(19) United States
(12) Patent Application Publication
(10) Pub. No.: US 2010/0005515 A1
(43) Pub. Date: Jan. 7, 2010

(54) SYSTEMS AND METHODS FOR ASSOCIATE TO ASSOCIATE AUTHENTICATION

(75) Inventors: Elizabeth S. Votaw, Potomac, MD (US); Robin K. Fowler, Wenatchee, WA (US)

Correspondence Address: Weiss & Arons, LLP, 1540 Route 202, Suite 8, Pomona, NY, 10970, US

(73) Assignee: Bank of America, Charlotte, NC (US)

(21) Appl. No.: 12/165,701

(22) Filed: Jul. 1, 2008

(51) Int. Cl. H04L 9/32

(52) U.S. Cl. 726/6

(57) ABSTRACT

Systems, methods and consumer-readable media for providing a platform between a requesting associate and an authenticating entity associate are provided. The method may include receiving a request for authentication from the requesting associate and transmitting the request to the authenticating associate. The method may include receiving a request for a single-use verification code from the authenticating associate in response to the request for authentication. The method may also include generating the single-use verification code, or, perhaps retrieving the single-use verification code from storage and transmitting the single-use verification code to the authenticating associate. Once the requesting associate has receiving the code from the authenticating associate, the requesting associate may enter the code. The system may then display the identity of the requesting associate on a workstation associated with the authenticating associate.

### FIELD OF TECHNOLOGY

Aspects of the disclosure relate to information security.

### BACKGROUND

“Fraudsters”—i.e., individuals attempting to perpetrate identify theft on an entity—use a variety of methods to perpetrate identity theft, often attempting to exploit weaknesses in entity authentication methods. In addition to traditional methods of identity theft, fraudsters increasingly use entity associate impersonations to perform high risk transactions like customer address changes and funds transfers. Typically, entities rely on associate identification numbers during an associate to associate authentication process. However, these pieces of information may be compromised.

The following is one specific example of a circumstance in which information has been compromised in the past. To increase customer satisfaction, associates in an entity customer center and client managers often act on behalf of the customer when contacting internal customer service units by telephone. The calling associate acts as a proxy for the customer and, consequently, associate authentication substitutes for customer authentication.

This scenario creates risks for the customers because a fraudster who has obtained an associate's identification information can act on behalf of a customer without their knowledge. Such an act of fraud can also impact an innocent associate's ability to do his job. For example, once an associate's identification number has been compromised, that associate is effectively “blacklisted” and it is very difficult to change an associate's identification number to allow him to continue to efficiently service customers. The associate identification number is tied to an associate's personnel profile and is generated based on several key pieces of his profile.

All entities face these and similar risks, yet most entities continue to rely on static information as the basis of associate authentication.

In view of security concerns, it would be desirable to provide systems and methods to help increase information security, especially with respect to intra-entity associate communications.

### SUMMARY OF THE INVENTION

It is an object of this invention to provide systems and methods to provide systems and methods to help increase information security, especially with respect to intra-entity associate communications.

An apparatus according to the invention may include an electronic communication platform between an initiating entity associate and an authenticating entity associate. The apparatus may include a first workstation. The first workstation may include a workstation storage device and a workstation processor connected to the workstation storage device. The workstation storage device may store a workstation program for controlling the workstation processor. The workstation processor may be operative with the workstation program to receive a first level security code and a verification code from an initiating associate.

A second workstation may include a workstation storage device. The second workstation processor may be connected to the workstation storage device. The workstation storage device may store a workstation program for controlling the workstation processor.

The workstation processor may be operative with the workstation program to receive a first level security code and the verification code from an authenticating associate.

A system may also include a server operative to communicate with the first workstation and the second workstation in order to receive the first level security code from the initiating associate and the first level security code from the authenticating associate. The server may be further operative to receive a request for authentication from the initiating associate.

The server may include a server storage device and a server processor connected to the server storage device. The server storage device may store a server program for controlling the server processor. The server processor may be operative with the server program to receive a request for a single-use verification code from the authenticating associate in response to the request for authentication, generate the single-use verification code, transmit the single-use verification code to the authenticating associate, receive input of the code from the authenticating associate; and display the identity of the initiating associate on a workstation associated with the authenticating associate.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 illustrates a schematic diagram of a general-purpose digital computing environment in which one or more aspects of the present invention may be implemented;

FIG. 2 shows an illustrative flow diagram of a process in which a method and/or systems according to the invention can be implemented;

FIG. 3 shows an illustrative flow diagram of a process for associate to associate authentication according to the invention;

FIG. 4 is a first screen shot according to the invention;

FIG. 5 is a second screen shot according to the invention;

FIG. 6 is a third screen shot according to the invention;

FIG. 7 is a fourth screen shot according to the invention;

FIG. 8 is a fifth screen shot according to the invention;

FIG. 9 is a sixth screen shot according to the invention;

FIG. 10 is a seventh screen shot according to the invention; and

FIG. 11 is an eighth screen shot according to the invention.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

Technology exists today to generate a single-use PIN. Single-use Personal Identification Numbers (“PINs”) may be valid for only a specified time frame—e.g., 30 seconds. Single-use PINs are currently being used in various form factors including tokens (shaped like a key fob), punch cards, credit/debit cards with built in flat screens, and SMS messaging. All of these factors typically require an enrollment process and a delivery process, often making the process expensive and unappealing.

Furthermore, Single Sign On (SSO) authentication architecture also exists. SSO protects entities from external fraudsters attempting to access bank systems. High risk systems and areas of the entity's intranet are protected by this architecture, which requires the associate to enter his ID number and a password.

Systems and methods according to the invention preferably strengthen security by creating a single-use dynamic PIN that is preferably implemented together with a Single Sign On (“SSO”) architecture, instead of embedding it in a system used only by some associates. An SSO architecture preferably includes any entity-wide architecture that allows for signing ON using a PIN.

One aspect of the invention relates to combining a single-use PIN generator technology with associate PIN exchange protocol for authentication and protecting the process under existing SSO architecture. Furthermore, methods and systems according to the invention move associate authentication from a static environment to a dynamic one, while not creating the need for any additional enrollment, delivery processes, or further maintenance processes. Such systems according to the invention also do not require memorization, storage or tracking of any new passwords or PINs.

Systems and methods according to the invention preferably provide a secure and user-friendly tool for authenticating associates within an entity. Such authentication may occur when entity associates are exchanging sensitive information such as customer data. Systems and methods according to the invention preferably eliminate the need to rely on traditional static associate identification information when authenticating and instead provide a dynamic, less easily compromised environment. These tools could be expanded to be used when authenticating vendor associates, contract associates, and other third party associates. These tools, as set forth in more detail below, could use a web-based “one time PIN” generator and could further leverage the security achieved through SSO authentication architecture.

Systems and methods according to the invention provide a secure method of associate authentication that reduces fraud and allows customer service associates to provide a higher level of service for internal and external customers.

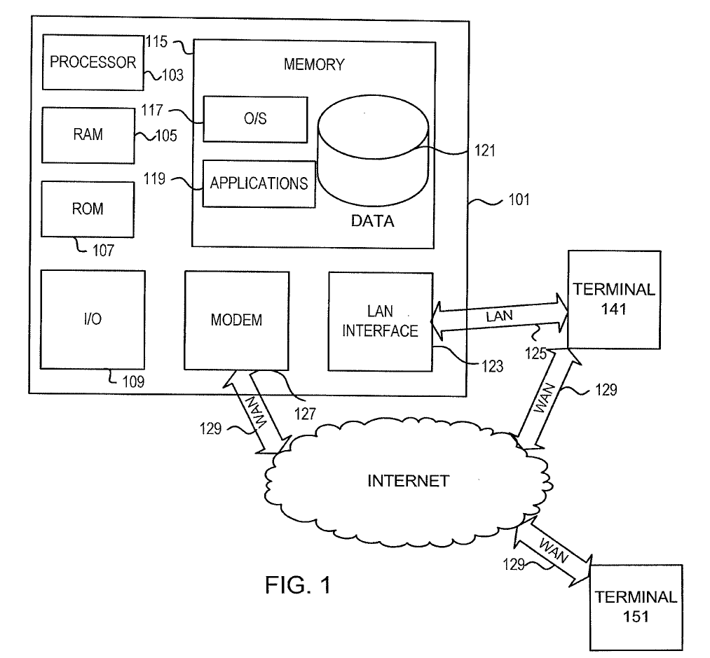

FIG. 1 illustrates a block diagram of a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 115.

I/O module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 121. Alternatively, some or all of server 101 computer executable instructions may be embodied in hardware or firmware (not shown). As described in detail below, database 121 may provide centralized storage of account information and account holder information for the entire business, allowing interoperability between different elements of the business residing at different physical locations.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119 used by server 101 according to an illustrative embodiment of the invention may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

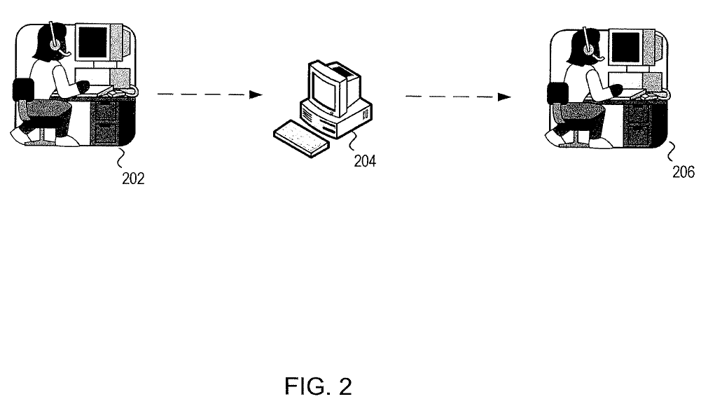

FIG. 2 shows that the process begins when an associate in an entity 202 needs customer information or needs to act on behalf of a customer. The entity associate 202 calls a customer service area 204 of the entity and requests service. The customer service agent 206 may be contacted via customer service area 204. Customer area 204 may preferably inform agent 206 that associate 202 has initiated a request for authentication.

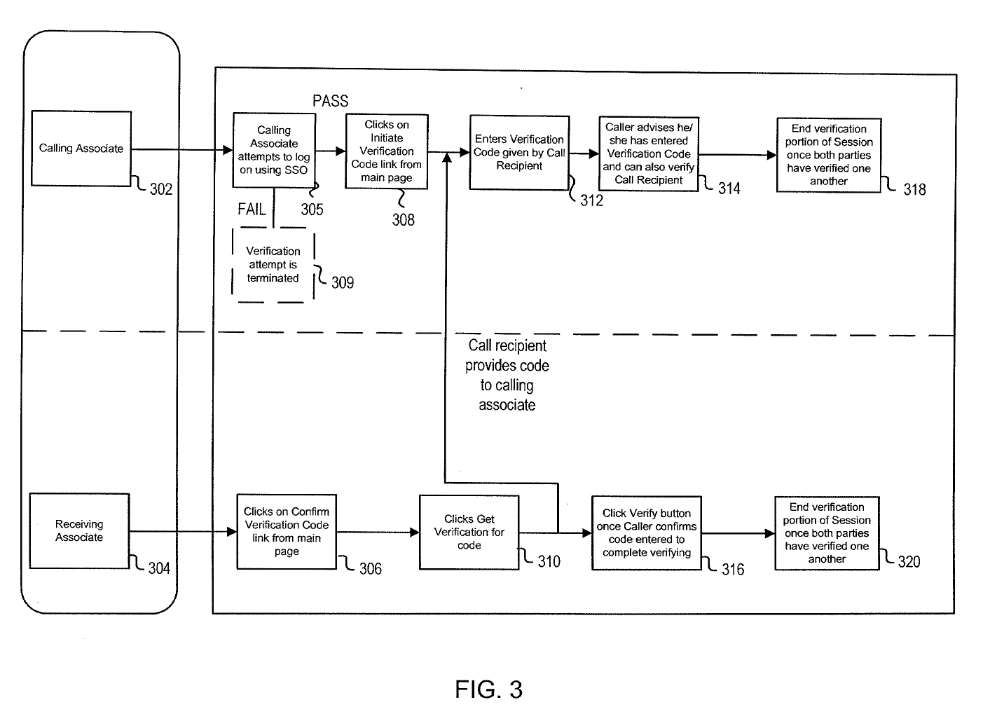

FIG. 3 shows an illustrative flow diagram according to the invention. FIG. 3 shows a calling associate 302 and a call receiving associate 304. Typically, such a process may begin with the calling associate calling in to a call service area (as shown in FIG. 2). The process continues when the calling associate provides his or her name to the receiving associate.

It should be noted that, at this point, preferably both the calling associate and the receiving associate have successfully signed into the Bank's systems via SSO. Thus, if the calling associate is already logged-in to the SSO, then the authentication process may be initiated. If, for any reason, the calling associate is not logged in to SSO, then the authentication process may not be initiated.

It should also be noted that neither associate is required to have entered the Single Sign On immediately prior to using the authentication website. Rather, both associates only need to be entered into an SSO system, or some other suitable identity-secure system at some point prior to accessing the authentication website.

To initiate the authentication process, both the calling associate and the receiving associate may navigate to the Associate verification page which will be located on an internal entity webpage. The calling associate and the receiving associate can access the authentication site, as shown in box 305.

Step 306 shows the calling associate clicking on a generate verification code link from main page. Step 308 shows the receiving associate clicking on a validate verification code link from a main page of the web site.

Step 310 shows the calling associate requesting the verification code. Upon receiving the verification code, the calling associate preferably provides the verification code to the receiving associate at step 311. Step 312 shows the receiving associate entering the verification code provided by the calling associate.

Step 314 shows the calling associate clicking the verify button once the receiving associate confirms that the code is entered. The calling associate preferably clicks the verify button to complete verifying. Step 316 shows the receiving associate advising he/she has entered verification code and can also verify the calling party. The clicking shown in step 316 preferably completes the user input information verifying process. Steps 318 and 320 show the end of the verification portion of the session once both parties have verified one another.

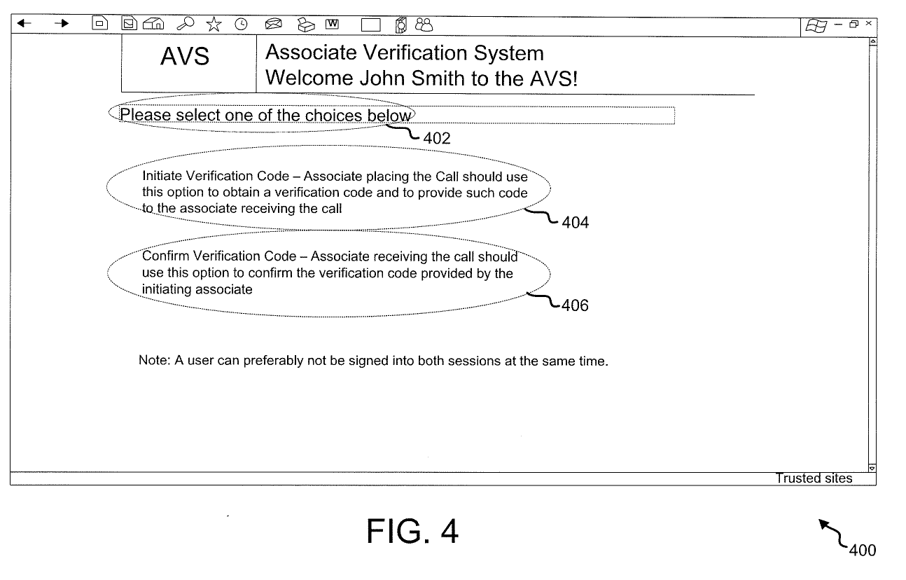

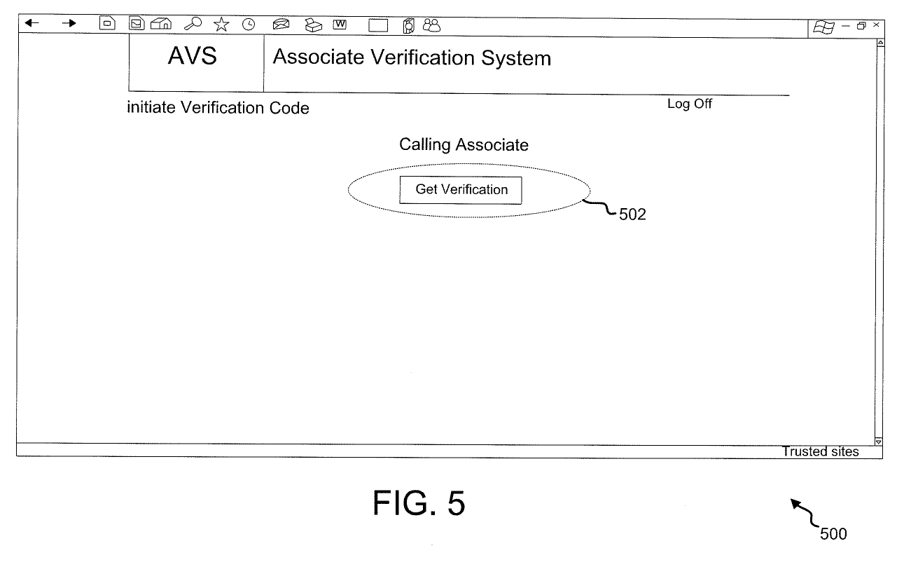

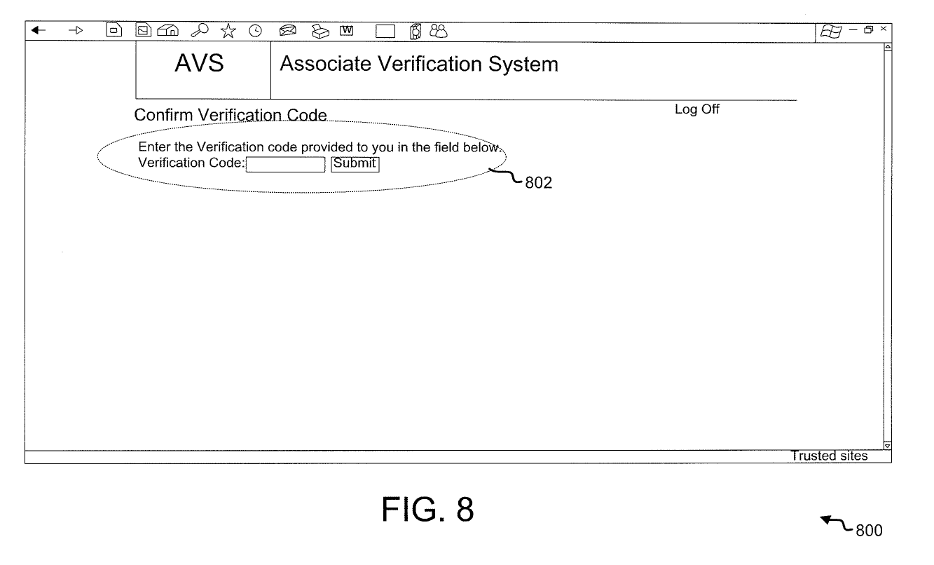

FIGS. 4-7 show exemplary screen shots that may be used in systems and methods according to the invention. The screen shots shown in FIGS. 5-7 may preferably illustratively represent screen shots that can be exclusively calling-associate facing. FIGS. 8-11 may preferably illustratively represent screen shots that can be exclusively receiving-associate facing.

FIG. 4 shows a screen 400 that may be used by either a calling associate or a receiving associate to access a verification system according to the invention. Instructions 402 are provided. A calling associate may preferably select circle 404 while a receiving associate may preferably select circle 406. The calling associate is referred to herein in the alternative, as an “initiating associate” because the calling associate preferably initiates the verification process—i.e., the calling associate is desirous of some response from the receiving associate and, therefore, bears the burden of verifying his or her identity.

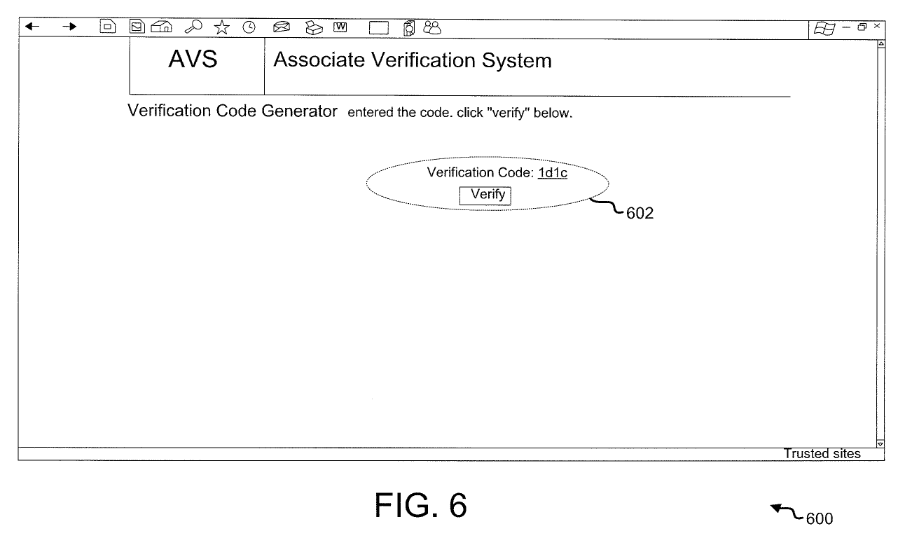

Following selection by the initiating associate, FIG. 5 shows screen shot 500. Screen shot 500 preferably includes a button 502 for getting verification. Selection of button 502 preferably obtains a verification code, which may be a four-digit alpha-numeric code or other suitable code, that the calling associate can then input into and select verification 602, as shown in screen shot 600 in FIG. 6. Screen shot 600 preferably shows linking of the calling associate with the verification code.

In one embodiment of the invention, the verification code may be transmitted via e-mail or may appear on the screen of the calling associate. Alternatively, the verification code may be transmitted to the calling associate and the receiving associate using any suitable method.

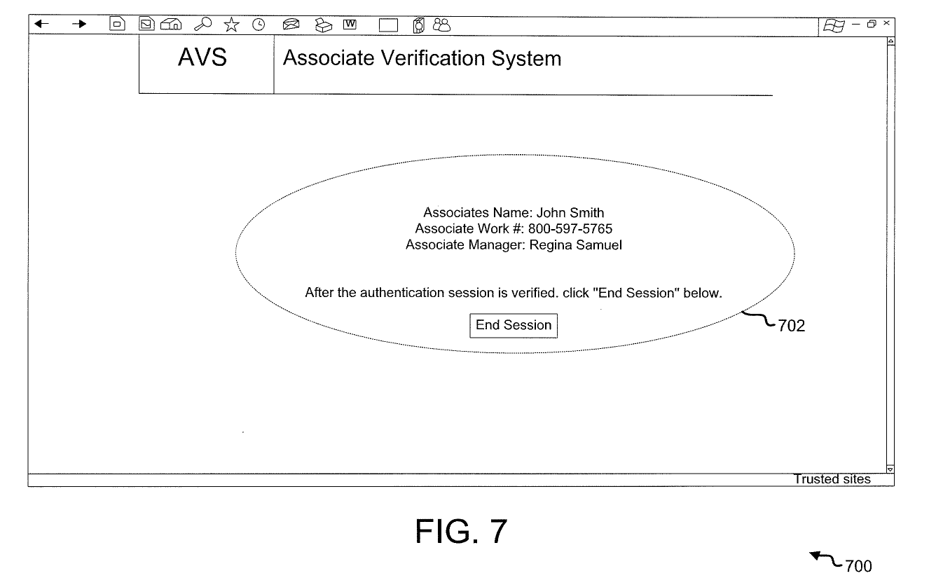

Once the calling associate inputs the verification code and clicks Verify in 602, the calling associate may confirm that the name appearing on his display, as shown in screen shot 700 in FIG. 7 at 702, matches the name of the receiving associate.

FIG. 8 shows the first of the preferably exclusively receiving associate-facing screens 800. Screen 800 preferably includes a field for the receiving associate to enter the verification code. Once the receiving associate has entered the verification code, then he/she may submit the verification code.

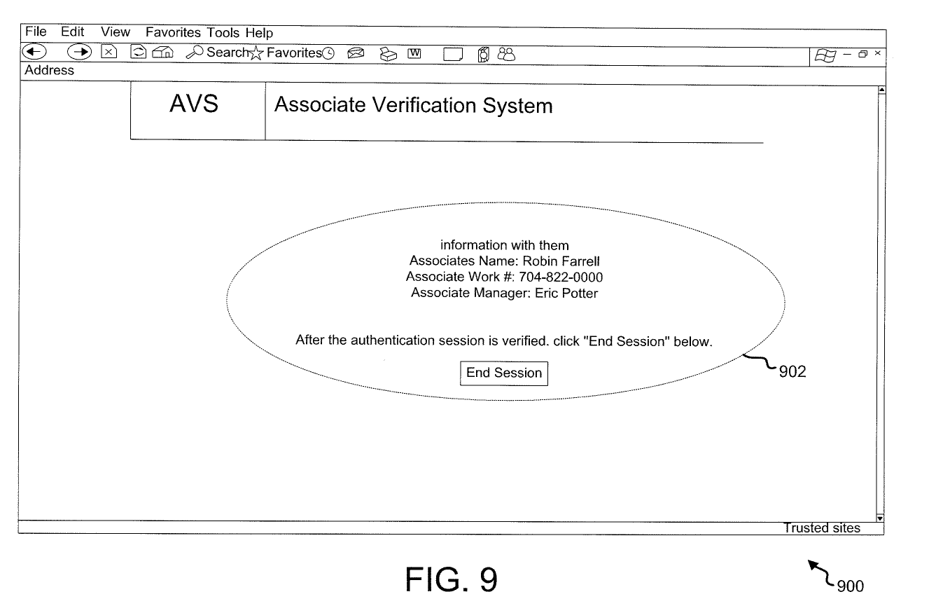

FIG. 9 shows screen 900 wherein information has been provided in area 902. If the information on the receiving associate screen matches the information provided by the calling associate, the receiving associate may then select end session and the verification has been successfully implemented. If the information does not match or the calling associate does not properly authenticate, the receiving associate should be instructed to not proceed with the transaction.

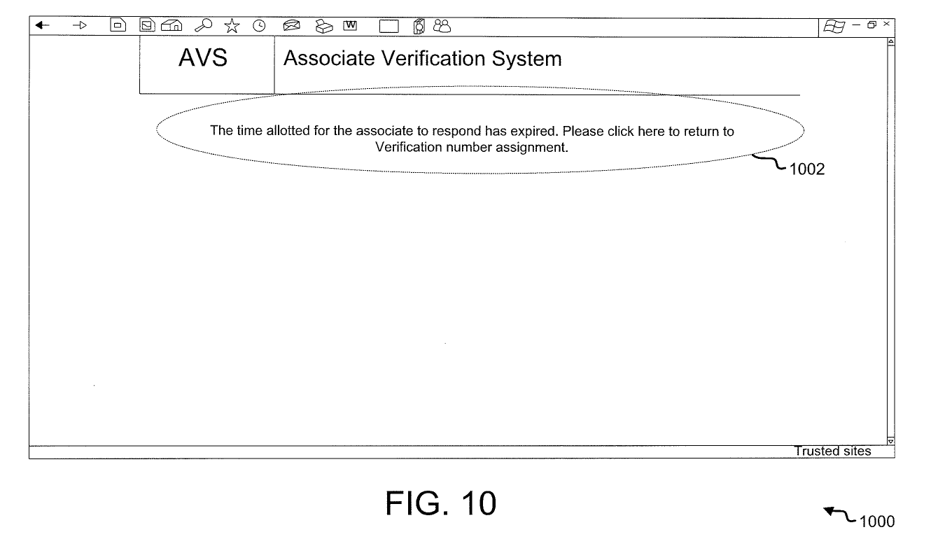

In certain embodiments of the invention, a delay on the part of one or both of the associates may cause an expiration of the current verification code, as shown in screen 1000, area 1002, in FIG. 10.

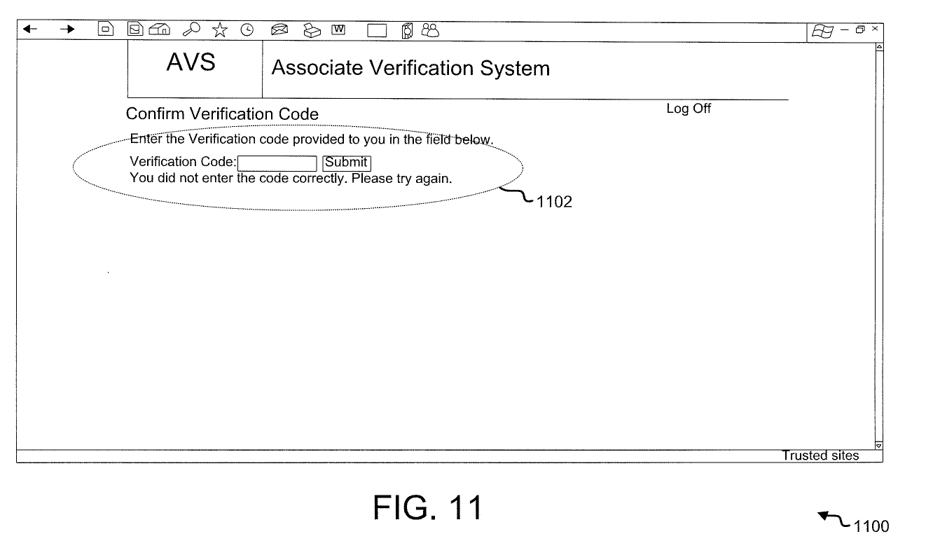

In some embodiments of the invention, incorrect entry of the verification code may prompt a renewed request for the correct verification code, as shown in screen 1100, area 1102, in FIG. 11.

It should be noted that, following the termination of the verification process according to the invention, the single-use PIN preferably expires and cannot be used again for a different session. The restriction on use of the PIN may extend for a predetermined time, or for a predetermined group of associates or according to some other predetermined set of parameters. It should be understood, however, that if the PIN is randomly generated for a different verification following the termination of the verification, systems and methods according to the invention may preferably set a flag that a second random generation, or other suitable creation, of a single-used PIN may be allowed. Alternatively, the system may disqualify a certain PIN based in order to insure that fraudulent activity is minimized.

Some embodiments of use of this tool according to the invention may include allowing customer service agents to perform transactions for client-managers without preferably directly involving their clients. Such transactions performed on behalf of the clients may include resetting passcodes for a customer; placing trades for a customer; changing addresses for a customer; transferring funds for a customer or preferably any other customer-facing, or otherwise customer-involved, transaction.

Other embodiments of the invention may preferably provide a platform for authorized offshore associates to access customer data.

Other embodiments of the invention may allow the associates to conduct their own personal business as needed with the entity—e.g., if the entity was a bank, the associates could conduct their personal banking—without requiring that the associates authenticate personal private information.

Additional embodiments of the invention may allow associates to pass Personnel Center authentication even if a voice recognition unit, or other layer of additional security, is bypassed.

Still other embodiments of the invention may allow for tracking of associate to associate authentication incidents and fraud attempts. Such tracking, and data obtained therefrom, may aid in investigation of fraud cases.

The use of a dynamic PIN generator internally to an entity in order to authenticate associate-to-associate communication has been described herein. One output of systems and methods according to the invention is the ability to authenticate any associate located at a location that can access the bank SSO architecture. The added security of this tool over conventional processes would enable customer service agents to perform more transactions for other associates, thereby reducing cost to serve, and increasing customer and associate satisfaction. Other outputs may be increased tracking ability of associate to associate call volume as well as valuable investigative data for fraud cases.

Furthermore, any suitable entity whose associates handle sensitive data and need to exchange that data across the entity may make use of systems and methods according to the invention. Thus, tool according to the invention could be used by entities that have their own internal authentication architecture for their employees and need a way to protect data exchanges between employees.

Vendors that support entity customers directly and need to rely on entity associates because they do not have access to entity systems may also be helped by systems and methods according to the invention. In such circumstances, the systems and methods according to the invention may need to integrate vendor internal authentication architecture with the SSO, to allow for two way authentication while still maintaining firewalls separating the two companies.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Aspects of the invention have been described in terms of illustrative embodiments thereof. A person having ordinary skill in the art will appreciate that numerous additional embodiments, modifications, and variations may exist that remain within the scope and spirit of the appended claims. For example, one of ordinary skill in the art will appreciate that the steps illustrated in the figures may be performed in other than the recited order and that one or more steps illustrated may be optional. The methods and systems of the above-referenced embodiments may also include other additional elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, systems and methods for associate to associate according to the invention have been provided. Persons skilled in the art will appreciate that the present invention can be practiced by other than the described embodiments, which are presented for purposes of illustration rather than of limitation, and the present invention is limited only by the claims which follow.

What is claimed is:

1. One or more computer-readable media storing computer-executable instructions which, when executed by a processor on a computer system, perform a method for providing a platform between an initiating entity associate and an authenticating entity associate, the method comprising:
receiving a first level password from the initiating associate;
receiving a first level password from the authenticating associate;
receiving a request for authentication from the requesting associate;
generating a single-use verification code in response to the request for authentication;
transmitting the single-use verification code to the requesting associate;
receiving input of the code from the authenticating associate; and
displaying the identity of the requesting associate on a workstation associated with the authenticating associate.

2. The method of claim 1 further comprising transmitting a single-use verification code to the authenticating associate.

3. The method of claim 1 further comprising displaying the identity of the authenticating associate on a workstation associated with the initiating associate.

4. The method of claim 1 further comprising providing a platform for transmitting the code from the authenticating associate to the initiating associate.

5. The method of claim 1 further comprising limiting the viability of the verification code to a predetermined amount of time from creation of the verification code.

6. The method of claim 1 further comprising using a random number generator to generate the verification code.

7. The method of claim 6 further comprising, when the random number generator generates a number that corresponds to a verification code that has been used previously, allowing the verification code to be used again for the initiating associate or for a second initiating associate.

8. The method of claim 1 further comprising authenticating the requesting associate in response to the first level password.

9. The method of claim 1 further comprising authenticating the authenticating associate in response to the first level password.

10. An apparatus for providing a platform between an initiating entity associate and an authenticating entity associate, the apparatus comprising:
a first workstation comprising:
a workstation storage device; and
a workstation processor connected to the workstation storage device, the workstation storage device storing a workstation program for controlling the workstation processor;
the workstation processor operative with the workstation program to receive a first level security code and a verification code from the initiating associate;
a second workstation comprising:
a workstation storage device; and
a workstation processor connected to the workstation storage device, the workstation storage device storing a workstation program for controlling the workstation processor;
wherein the workstation processor is operative with the workstation program to receive a first level security code and the verification code from the authenticating associate; and
a server operative to communicate with the first workstation and the second workstation to receive the first level security code from the initiating associate and the first level security code from the authenticating associate, the server further operative to receive a request for authentication from the initiating associate, the server comprising:
a server storage device;
a server processor connected to the server storage device, the server storage device storing a server program for controlling the server processor;
wherein the server processor is operative with the server program to:
receive a request for a single-use verification code from the authenticating associate in response to the request for authentication;
generate the single-use verification code;
transmit the single-use verification code to the initiating associate;
receive input of the code from the authenticating associate; and
display the identity of the initiating associate on a workstation associated with the authenticating associate.

11. The apparatus of claim 10 wherein the server processor is further operative with the server program to transmit the single-use verification code to the initiating associate.

12. The apparatus of claim 10 wherein the server processor is further operative with the server program to display the identity of the authenticating associate on a workstation associated with the initiating associate.

13. The apparatus of claim 10 wherein the server processor is further operative with the server program to provide a platform for transmitting the code from the authenticating associate to the initiating associate.

14. The apparatus of claim 10 wherein the server processor is further operative with the server program to limit the viability of the verification code to a predetermined amount of time from creation of the verification code.

15. The apparatus of claim 10 wherein the server processor is further operative with the server program to use a random number generator to generate the verification code.

16. The apparatus of claim 15 wherein, when the random number generator generates a number that corresponds to a verification code that has been used previously, the server processor is further operative with the server program to allow the verification code to be used again for the initiating associate or for a second initiating associate.

17. The apparatus of claim 10 wherein the server processor is further operative with the server program to allow the initiating associate to request authentication in response to receiving the first level password.
